(19) United States
(12) Patent Application Publication
(10) Pub. No.: US 2020/0298455 A1
(43) Pub. Date: Sep. 24, 2020

(54) Method for producing a roof element of a motor vehicle and roof element having a moulded section

(71) Applicant: WEBASTO SE, Stockdorf (DE)

(72) Inventors: Markus RAUCH, Stockdorf (DE); Martin SACHER, Mehrum (DE); Jan WOKOECK, Lehrte (DE); Alexander ISBACH, Stockdorf (DE); Karl-Heinz BARTL, Stockdorf (DE)

(21) Appl. No.: 16/088,497

(22) PCT Filed: Feb. 3, 2017
(86) PCT No.: PCT/EP2017/052378

§ 371 Date: Sep. 26, 2018

(30) Foreign Application Priority Data
Mar. 30, 2016 (DE) 10 2016 105 785.1

(51) Int. Cl. B29C 44/12

(52) U.S. Cl. CPC B29C 44/1271; B60J 7/043

(57) ABSTRACT

A roof element and a process for the production of a roof element are provided, which may have the steps of providing a polymer mixture; admixing an organosiloxane compound with the polymer mixture; a mixing of the polymer mixture, with the organosiloxane compound admixed, with an isocyanate compound to give a polyurethane material and introduction of the polyurethane material into a mold cavity of a foaming mold in a manner such that the polyurethane material reacts to completion and a molded section of the roof element is shaped in the mold cavity wherein the organosiloxane compound is accumulated at the surface of the molded section, wherein in a surface layer of thickness from 0.5 μm to 20 μm of the molded section, the organosiloxane compound is accumulated; and demolding of the roof element from the foaming mold.

The invention relates to a process for the production of a roof element of a motor vehicle, and to a roof element with the features of the preamble of claim 6.

Roof elements of motor vehicles are in many cases composed of a glass panel, and form a cover element of a roof-opening system to which, for coupling to the vehicle structure, a peripheral foam edging has been provided, which is composed of a polyurethane material and into which fixing brackes can be embedded. The peripheral foam edging is produced in a foaming mold which has a cavity into which the polyurethane material is introduced for the formation of the foam edging. The polyurethane material consists of a polymer mixture, in particular a polyol mixture, and an isocyanate compound. During the molding process or foaming process, the polymer mixture and the isocyanate compound are passed into a mixing head, where they are mixed, and are then introduced into the cavity for completion of the reaction. After reaction of the polyurethane material has been completed and said material has hardened, the finished workpiece, i.e. the glass panel with the foam edging, can be demolded from the foaming mold.

In order that no damage occurs to the workpiece during demolding from the foaming mold, it has hitherto been necessary to provide a release agent to the mold cavity of the foaming mold, or to the mold wall delimiting the mold cavity. This is achieved manually by means of a release agent applicator which has to be kept available by the foaming mold for this specific purpose, and which generally comprises what is known as a release agent gun, and incurs high cost. The release agent forms, on the molded section shaped in the mold cavity, a release film that prevents adhesion of the molded section on the foaming mold. Because the release agent is applied manually, the thickness of the release film can vary greatly. There are therefore likewise large differences in any possible residues on the molded section manufactured in the foaming mold. The release agent residues can have a considerable effect on the adhesive-bonding capability of the molded section.

During the course of a production shift, i.e. during the manufacture of a large number of mold sections in the relevant mold, the release agent moreover forms a release film with increasing thickness. This release film has to be removed at the end of the relevant production shift, i.e. the mold has to be cleaned to remove the release agent.

The application procedure moreover leads to formation of a release agent mist, to which the respective operator is exposed, and which can be hazardous to health.

The invention is based on the object of providing a process which can produce a roof element of a motor vehicle and in which the abovementioned problems resulting from the release agent are eliminated.

According to the invention, said object is achieved by the process with the features of claim 1.

The invention therefore proposes a process for the production of a roof element of a motor vehicle, with the following steps:
Provision of a polymer mixture;
Admixture of an organosiloxane compound with the polymer mixture;
Mixing of the polymer mixture, with the organosiloxane compound admixed, with an isocyanate compound to give a polyurethane material and introduction of the polyurethane material into a mold cavity of a foaming mold in a manner such that the polyurethane material reacts to completion and a molded section of the roof element is shaped in the mold cavity wherein the organosiloxane compound is accumulated at the surface of the molded section; and
Demolding of the roof element from the foaming mold.

The process of the invention therefore uses a polyurethane material which comprises, in the form of a high-molecular-weight, long-chain organosiloxane compound, an internal release agent, the concentration of which at the surface of the molded section formed in the mold cavity of the foaming mold becomes relatively high during the foam process, thus ensuring demolding of the roof element comprising the molded section from the foaming mold. It is therefore possible to omit use of an external release agent, with which the foaming mold has hitherto been sprayed in the region of the mold cavity.

There is therefore no requirement for a complicated release agent applicator associated with the foaming mold. With no use of an external release agent, it is also possible to operate the foaming mold with shorter cycle times, because the release agent cycle for the application of the external release agent is omitted. It is moreover possible to ensure that the organosiloxane compound providing an internal release agent forms a substantially constant release agent layer at the surface of the molded section, because said agent is present with uniform distribution in the relevant surface-structure matrix of the polyurethane material. The physical properties of the molded section are not adversely affected by the organosiloxane compound in comparison with those of a molded section without organosiloxane compound as internal release agent. Instead, the molded section has an unchanged polymer matrix, which is a decisive factor for physical properties such as hardness, tensile strength and elongation at break. There is moreover no need for any further reactivity-balancing additives, because the organosiloxane compound does not change the chemistry of the molded section in its central regions. Specifically, during the reaction of the polymer mixture with the isocyanate compound, the organosiloxane compound is displaced outward in the direction of the mold wall. This takes place because of the heat produced during the reaction, leading to phase separation. The temperatures of rising during the reaction of the polymer mixture with the isocyanate compound can be above 100° C. The organosiloxane compound has no effect on the reactivity of the polyurethane system formed from the polymer mixture and from the isocyanate compound for conduct of an RIM (Reaction Injection Molding) process.

During the reaction, therefore, the long-chain molecules of the organosiloxane compound are displaced to the surface of the polyurethane material via migration, convection and exothermic energy, and specifically within the first milliseconds of the reaction. Because the organosiloxane compound has a long-chain structure, it remains, in the manner of a surfboard, at the surface, i.e. in the region of the interface with the mold wall in the region of the mold cavity of the foaming mold. Toward the end of the reaction, the organosiloxane compound is to some extent incorporated by bonding into the polyurethane matrix. A uniform, fine dispersion of the organosiloxane compound is achieved here at the surface of the molded section. This behavior of the organosiloxane compound was demonstrated by means of gas chromatography and mass spectrometer studies. The organosiloxane compound thus forms, between the fully reacted polyurethane material and the mold wall, a release film which prevents adhesion of the polyurethane on the mold wall. The organosiloxane compound specifically permits cohesive fracture between the foaming mold and the molded section, thus providing deformability.

An organosiloxane has the following general structural formula:

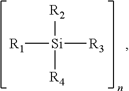

where n is an integer and R₁, R₂, R₃ and R₄ are organic groups.

When the intention is to arrange, within the polyurethane material, inserts made of a coated metal, in particular cathodically electrocoated metal, these bond successfully to the molded section, despite the organosiloxane compound, because the cathodic electrocoating material itself comprises binders, pigment paste and water-miscible organic solvents. The substantial constituents of the binder and of the pigment paste are frequently epoxy-resin-amine adducts and blocked isocyanates. The binders and the pigment paste form the major portion of the solids present in the solution for production of the cathodic electrocoating material. The binder of the cathodic electrocoating material, especially the isocyanate, ensures production of a sufficient number of linkage points between the cathodic electrocoating material and the molded section of the polyurethane material.

In a specific embodiment of the process of the invention, which ensures good deformability of the roof element from the foaming mold, with no impairment of the physical properties of the molded section, a quantity of from 0.5% by weight to 8% by weight of the organosiloxane compound is admixed with the polymer mixture.

The molar mass of the organosiloxane compound used can be from 15 000 g/l to 50 000 g/l.

The organosiloxane compound used therefore comprises long-chain organosiloxanes, and is an internal release agent, and specifically is unlike short-chain siloxanes, which can be cell stabilizers and do not serve as release agents.

The polymer mixture provided during the process of the invention is preferably a polyol composition. Firstly, the organosiloxane compound is added thereto. Secondly, the isocyanate compound is admixed with the polyol composition in a mixing and metering head, and the mixture is then introduced into the mold cavity.

In a preferred embodiment of the process of the invention, the molded section is shaped onto a panel consisting of glass or of a plastics material. The molded section then in particular forms a peripheral foam edging of the panel. When the roof element is a cover element of a roof-opening system, the peripheral foam edging is used to receive inserts, by way of which the panel can be covered to a kinematic system of the roof-opening system. The peripheral foam edging can moreover be used to receive a seal, or else can be used as sealing equipment intended, in a closed position of the cover element, to permit adequately leakproof closure of an appropriate roof opening of the relevant motor vehicle.

The organosiloxane compound which has relatively high concentration at the surface of the molded section also has no adverse effect on the coupling of the molded section to the glass panel, because a primer has been provided to the latter. The primer comprises binding elements that have affinity for isocyanate. At the surface having a relatively high concentration of the organosiloxane compound, despite the presence of the organosiloxane compound, there is still a sufficient quantity of free isocyanates present from the isocyanate compound of the polyurethane material, and these can link to the binding elements of the primer.

The process of the invention is used by way of example in high-pressure foaming processes which are known as RIM (Reaction Injection Molding) processes, or in low-pressure foaming processes in which the polyurethane material is introduced at ambient pressure into a mold and appropriate low-pressure metering equipment is used to introduce the material to the mold cavity. In the latter case, particular mention may be made of what are known as WST (Window Spray Technology) processes.

The invention also provides a roof element of a motor vehicle, comprising a molded section which has been manufactured from a material comprising polyurethane by a foaming process and which comprises an organosiloxane compound accumulated at its surface.

The organosiloxane compound is an integrated constituent of the molded section, and has been absorbed by the structure of the polyurethane material in fully reacted form thereof, where the organosiloxane compound consisting of high-molecular-weight, long-chain molecules forms, in the manufacturing mold for the molded section, a release film which permits demolding of the roof element without using of an external release agent.

In particular, the organosiloxane compound forms a surface layer of the molded section, the thickness of said layer being from 0.5 μm to 20 μm. The molar mass of the organosiloxane compound is preferably from 15 000 g/l to 50 000 g/l.

As already explained above in conjunction with the process of the invention, the roof element can be a cover element of a roof-opening system. The molded section then forms by way of example a peripheral foam edging of a panel which has been manufactured from glass or from a plastics material.

Further advantages and advantageous embodiments of the subject matter of the invention can be found in the description, the drawing and the claims.

An embodiment of a roof element of the invention and of a process for the production of the roof element are depicted in simplified diagrammatic form in the drawing, and are explained in more detail in the description below.

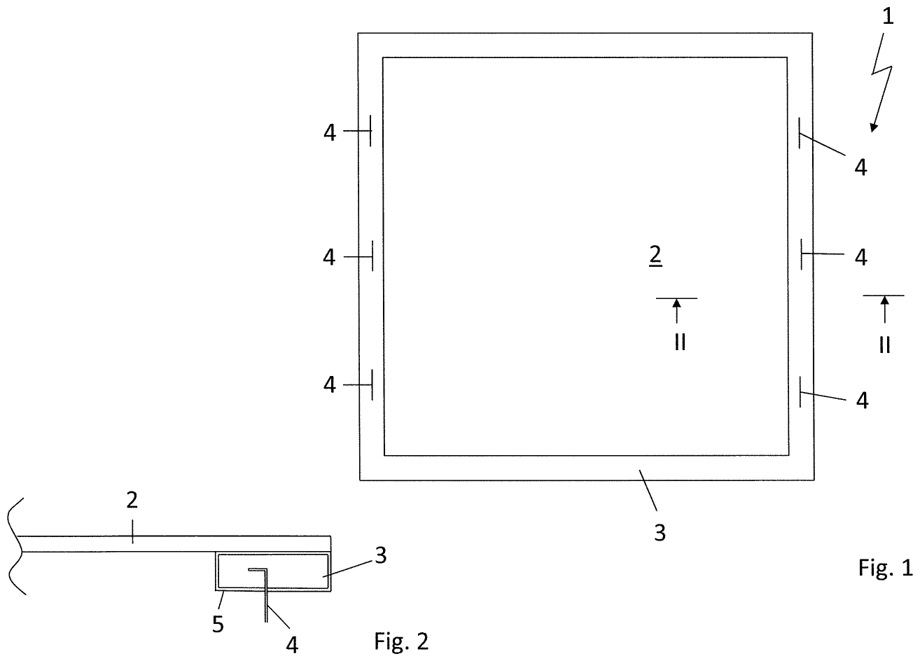

FIG. 1 is a plan view of a cover element of a roof-opening system of a motor vehicle;

FIG. 2 is a section through the cover element of FIG. 1 along the line II-II in FIG. 1;

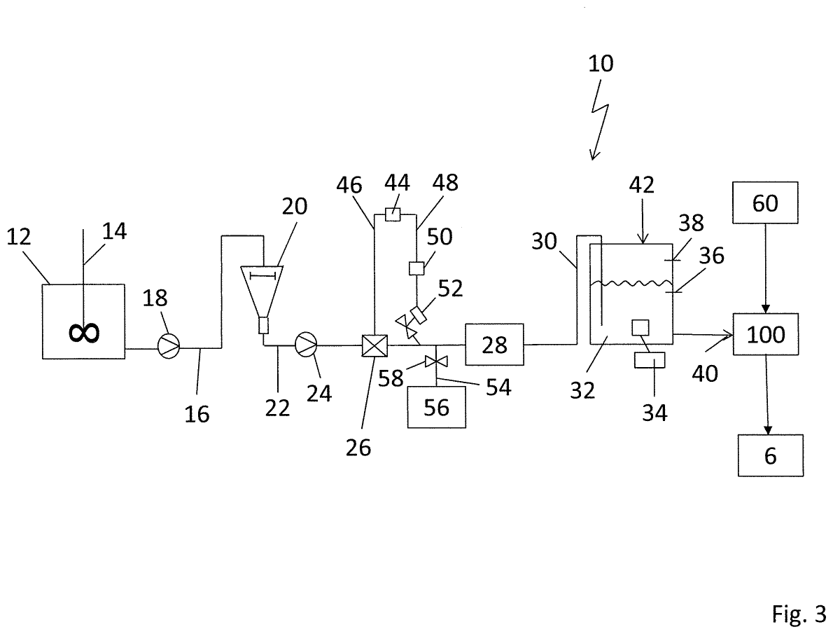

FIG. 3 shows a device for the preparation of a liquid polyol composition;

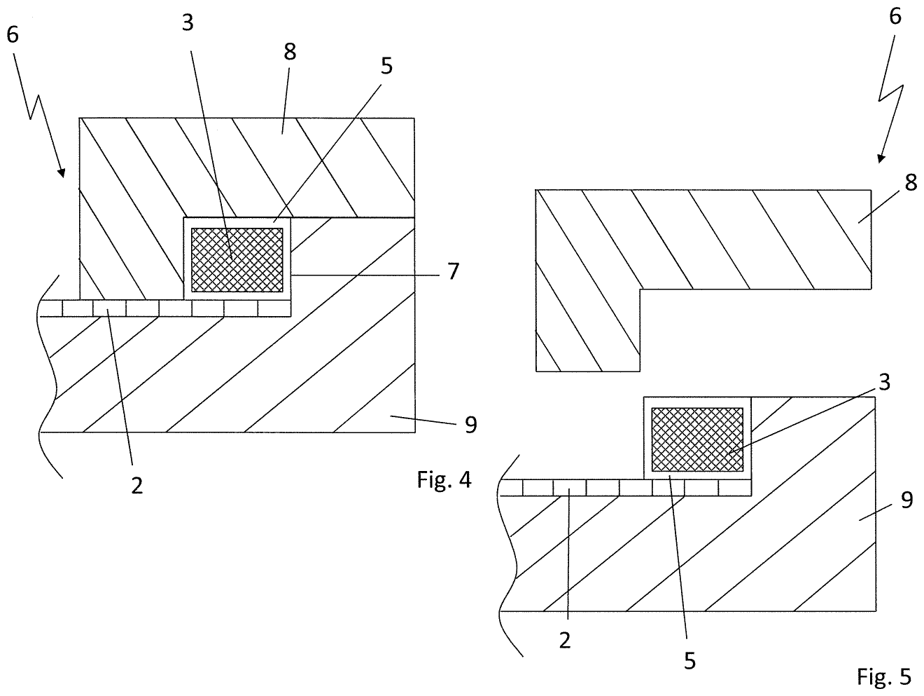

FIG. 4 is a detail of a sectional view of a mold for the production of a mold section of the cover element of FIG. 1, in closed position; and

FIG. 5 is a depiction of the foaming mold corresponding to FIG. 4, but in open position.

FIGS. 1 and 2 show a cover element 1 of a roof-opening system, in other respects not depicted in any greater detail, of a vehicle roof. By means of the cover element 1 it is possible, as desired, to close, or at least to some extent open, a roof opening of the vehicle roof.

The cover element 1 comprises a glass panel 2 that is in essence rectangular, to which a glass frit and a primer have been provided.

To permit coupling of the cover element 1 to a kinematic system for roof opening there is, provided to the glass panel 2 along its periphery, a foam edging 3 into which, at each of the edges that are lateral in relation to a vertical plane running centrally along the length of the roof, there are three retaining brackets 4 embedded as inserts. The retaining brackets 4 have each been manufactured from a cathodically electrocoated metal sheet.

The foam edging 3 consists of a polyurethane material with which an organosiloxane compound has been admixed. The organosiloxane compound is concentrated/accumulated within a surface layer 5 of the foam edging 3. The surface layer 5 has a thickness of some micrometers.

FIGS. 3 to 5 depict diagrammatically the production of the foam edging 3 of the cover element 1. The production process uses a foaming mold 6, depicted in FIGS. 4 and 5, in which there is a mold cavity 7 which corresponds to the shape of the foam edging 3 and which is delimited by an upper mold section 8 and a lower mold section 9 of the foaming mold 6.

During the production of the foam edging 3, the glass panel 2, to which the glass primer and the glass frit have been provided, is placed onto the lower mold section 9 while the foaming mold 6 is in the open position depicted in FIG. 5, where the upper mold section 8 and the lower mold section 9 have been moved apart. The retaining brackets 4 are moreover fixed in a manner not depicted. The upper mold section 8 is then moved toward the lower mold section 9 to form the mold cavity 7. The polyurethane material can then be introduced into the mold cavity 7 of the closed foaming mold 6 and reacted to completion there. The retaining brackets 4 also become embedded into the polyurethane material here.

An organosiloxane compound with molar mass from 15 000 g/l to 50 000 g/l has been admixed with the polyurethane material used. During the reaction of the polyurethane material to completion, the heat produced in the reaction causes a phase separation which forces the organosiloxane compound toward the cavity-delimiting surfaces formed by the upper mold section 8, the lower mold section 9 and the glass panel 2, thus forming the surface layer 5 with relatively high concentration of the organosiloxane compound on the foam edging 3. The finished cover element 1 can then be demolded. As can be seen from FIG. 3, the polyurethane material is passed from a metering and mixing head 100 into the foaming mold 6 and, respectively, the mold cavity 7.

In the mixing head 100, a polyol composition with which the organosiloxane compound has been admixed, and which has been prepared in a device 10, and an isocyanate compound available from a container 60 are mixed with one another and then metered into the mold cavity 7.

The device 10 for the preparation of the polyol composition, which is a reactive polymer for the polyurethane system, can be seen in FIG. 3.

The device 10 comprises a feed container 12 in which the polyol composition can be stored and to which a stirrer 14 has been provided in order to eliminate any possible layering of the polyol composition as a result of storage. The storage container 12 has connection by way of a line 16, with a pump 18 arranged therein, to degassing equipment 20, which is composed of a vacuum deaerator. Attached to the vacuum deaerator there is an output line 22, which has another pump 24 and a mass flow meter 26 arranged therein and which leads to homogenizing equipment 28, composed of a toothed colloid mill. Upstream of the homogenizing equipment 28 there is arranged, on the line 22, a metering valve 52 which is a constituent of gasification equipment and by way of which an additive gas can be added to the polyol composition.

Downstream of the metering valve 52 and upstream of the homogenizing equipment, an input line 54, which has been connected to a feed container 56 for the organosiloxane compound and to which there is also a valve 58 provided, enters the line 16.

The homogenizing equipment 28 has an output line 30 which leads into a container 32 in which the prepared polymer mixture can be placed for intermediate storage, and provided to which there is a stirrer unit 34. A gauge pressure of from 1 to 6 bar prevails in the container 32. The output line 30 leads into the container 32 in a manner such that the prepared polymer mixture is introduced below the existing upper surface of the polymer mixture already present in the container 32. The upper surface, or fill level, of the polymer mixture in the container 32 is always maintained between two marks; there is a first sensor 36 provided to the lower mark and a second sensor 38 provided to the upper mark. The sensor 36 allocated to the lower mark indicates when the level falls below the specified fill level in the container 32 and further liquid polymer mixture has to be prepared. The second sensor 38 allocated to the upper mark indicates when the level rises above the specified fill level, and the preparation of the liquid polymer mixture by means of the device 10 has to be stopped.

The container 32 has connection by way of an onrunning line 40 to the metering and mixing head 100 which is allocated to the foaming mold 6 for the production of the foam edging 3 of the cover element 1 and in which the isocyanate compound is added to the polyol composition to form the polyurethane system. A return line 42 moreover leads into the container 32 and, with the ongoing line 40, forms a circuit for the supply of a plurality of processing units.

For the control of the preparation of the polyol composition, the device 10 has control equipment 44 which has connection by way of a line 46 to the mass flow meter 26 and by way of a line 48 to a gas mass flow meter 50 likewise allocated to the gasification equipment, and to the metering valve 52, by means of which an additive gas, for example carbon dioxide or an inert gas, can be introduced into the liquid polyol composition, and specifically upstream of the homogenization equipment 28 and downstream of the mass flow meter 26. The control equipment moreover has connection to the valve 58 for the metered addition of the organosiloxane compound from the feed container 56 by way of the line 54.

The polyol composition can be prepared by means of the device 10 in the manner described below.

The polyol composition, which is stirred in the storage container 12, is conveyed by means of the pump 18 into the degassing equipment 20, where it is freed from undefined gases. The degassed polymer mixture consisting of the polyol composition is then conveyed through the output line 22 by means of the pump 24. The quantity of the polyol composition is first determined here by means of the mass flow meter 26, and then, as required by said measurement, by means of the control equipment 44, additive gas is added by way of the gas mass flow meter 50 of the metering valve 52 and the organosiloxane compound is added by way of the valve 58. Downstream of the valve 58, the polyol composition, now with additive gas and with the organosiloxane compound, is passed through the homogenizing equipment 28 in order to achieve fine dispersion, in the polyol composition, of small gas bubbles composed of the additive gas. The polyol composition thus prepared is then passed into the container 32 by way of the discharge line 30 so that it can be further processed, in particular via addition of an isocyanate to give a polyurethane system that can be used for the production of the rigid-foam edging of the cover element 1 or the like.

### LIST OF REFERENCE SIGNS

1 Cover element
2 Glass panel
3 Foam edging
4 Retaining brackets
5 Surface layer
6 Foaming mold
7 Mold cavity
8 Upper mold section
9 Lower mold section
10 Device
12 Storage container
14 Stirrer
16 Line
18 Pump
20 Degassing equipment
22 Output line
24 Pump
26 Mass flow meter
28 Homogenizing equipment
30 Discharge line
32 Container
34 Stirrer unit
36 Sensor
38 Sensor
40 Ongoing line
42 Return line
44 Control equipment
46 Line
48 Line
50 Gas mass flow meter
52 Metering valve
54 Supply line
56 Storage container
58 Valve
100 Metering and mixing head

1. A process for the production of a roof element of a motor vehicle, comprising the steps of:
providing a polymer mixture;
admixing an organosiloxane compound with the polymer mixture;
Mixing of the polymer mixture, with the organosiloxane compound admixed, with an isocyanate compound to give a polyurethane material and introduction of the polyurethane material into a mold cavity of a foaming mold in a manner such that the polyurethane material reacts to completion and a molded section of the roof element is shaped in the mold cavity wherein the organosiloxane compound is accumulated at the surface of the molded section,
wherein in a surface layer of thickness from 0.5 μm to 20 μm of the molded section, the organosiloxane compound is accumulated; and
Demolding of the roof element from the foaming mold.

2. The process as claimed in claim 1, wherein the quantity of the organosiloxane compound admixed with the polymer mixture is 0.5% by weight to 8% by weight.

3. The process as claimed in claim 1, wherein the molar mass of the organosiloxane compound is from 15 000 g/mol to 50 000 g/mol.

4. The process as claimed in claim 1, wherein the polymer mixture is a polyol composition.

5. The process as claimed in claim 1, wherein the molded section is shaped on a panel which comprises glass or which comprises a plastics material.

6. A roof element of a motor vehicle, comprising a molded section which has been manufactured from a material comprising polyurethane by a foaming process, wherein, at the surface of the molded section, an organosiloxane compound is accumulftated, wherein in a surface layer of thickness from 0.5 μm to 20 μm of the molded section, the organosiloxane compound is accumulated.

7. (canceled)

8. The roof element as claimed in claim 6, wherein the molar mass of the organosiloxane compound is from 15 000 g/mol to 50 000 g/mol.

9. The roof element as claimed in claim 8, wherein the roof element is a cover element of a roof-opening system.

10. The roof element as claimed in claim 9, wherein the mold section is a peripheral foam edging of a panel which comprises glass or which comprises a plastics material.
